(19) United States
(12) Patent Application Publication
(10) Pub. No.: US 2026/0084108 A1
(43) Pub. Date: Mar. 26, 2026

(54) VACUUM INSULATED CONTAINER

(71) Applicant: HONDA MOTOR CO., LTD., Tokyo (JP)

(72) Inventors: Naoto ISHII, Saitama (JP); Tomoya WATANABE, Saitama (JP); Takanori NUMANYU, Saitama (JP); Hiroko KIMOTO, Saitama (JP)

(21) Appl. No.: 19/335,448

(22) Filed: Sep. 22, 2025

(30) Foreign Application Priority Data
Sep. 26, 2024 (JP) 2024-167023

(51) Int. Cl. B01D 53/82; B01D 53/26; B01D 53/28; B01D 53/62; B65D 81/38

(52) U.S. Cl. CPC B01D 53/82; B01D 53/261; B01D 53/28; B01D 53/62; B65D 81/3818; B01D 2251/402; B01D 2251/404; B01D 2257/504; B01D 2257/80

(57) ABSTRACT

Provided is a highly-manufacturable vacuum insulated container capable of easily bringing an internal closed space into a vacuum state. A vacuum insulated container is a vacuum insulated container including an inner container and an outer container forming an internal closed space with the inner container. Further, the vacuum insulated container is the vacuum insulated container including an air outlet connected to the internal closed space, and a seal that seals the air outlet after vacuum evacuation by an exothermic reaction in the internal closed space.

This application is based on and claims the benefit of priority from Japanese Patent Application No. 2024-167023, filed on 26 Sep. 2024, the content of which is incorporated herein by reference.

### BACKGROUND OF THE INVENTION

### Field of the Invention

The present invention relates to a vacuum insulated container.

### Related Art

Conventionally, there has been known a technique related to an insulated structure for preventing heat transfer between objects. For example, Japanese Unexamined Patent Application, Publication No. 2010-222048 and Japanese Unexamined Patent Application, Publication No. 2006-167572 describe the technique of this type.

Japanese Unexamined Patent Application, Publication No. 2010-222048 relates to a vacuum insulated container including an inner container and an outer container. In Japanese Unexamined Patent Application, Publication No. 2010-222048, an exhaust pipe of an exhaust device is connected to a tip tube connected to an exhaust hole causing the inside and outside of the outer container to communicate with each other, vacuum evacuation is performed such that the degree of vacuum in an internal space reaches a predetermined degree, and thereafter, the internal space is brought into a vacuum state by sealing the tip tube and cutting off an unnecessary portion.

Japanese Unexamined Patent Application, Publication No. 2006-167572 relates to a gas adsorbent applied to an insulator. In Japanese Unexamined Patent Application, Publication No. 2006-167572, using the gas adsorbent including at least a silver-exchanged zeolite and a chemical moisture adsorption substance, the chemical moisture adsorption substance adsorbs and removes moisture which cannot be removed in an industrial vacuum evacuation process and internally-generated moisture. By the adsorption and removal of the moisture, the silver-exchanged zeolite expressing a nitrogen adsorption activity adsorbs and fixes nitrogen which cannot be removed in the industrial vacuum evacuation process and nitrogen entering over time. One example of the chemical moisture adsorption substance includes a chemical adsorbent and the like such as an oxide and a hydroxide of an alkaline metal and an alkaline earth metal.
Patent Document 1: Japanese Unexamined Patent Application, Publication No. 2010-222048
Patent Document 2: Japanese Unexamined Patent Application, Publication No. 2006-167572

### SUMMARY OF THE INVENTION

An internal closed space is brought into a vacuum state so that insulation of a container can be improved. However, for the vacuum state, it is necessary to bring the internal closed space into the vacuum state using equipment such as an exhaust device in an exhaust port connected to the internal closed space, to assemble components in the vacuum state, or the like. There is still room for improvement in manufacturability of the vacuum insulated container in the prior art.

The present invention is intended to provide a highly-manufacturable vacuum insulated container capable of easily bringing an internal closed space into a vacuum state.

(1) One aspect of the present invention is a vacuum insulated container (for example, vacuum insulated container 1, 1a described later) including an inner container (for example, inner container 10, 10a described later) and an outer container (for example, outer container 20, 20a described later) forming an internal closed space (for example, internal closed space 40 described later) with the inner container, which further includes an air outlet (for example, air outlet 21, 21a described later) connected to the internal closed space, and a seal (for example, seal 30 described later) that seals the air outlet after vacuum evacuation by an exothermic reaction in the internal closed space.

With this configuration, the state of the internal closed space brought into a low vacuum by pushing out air into atmosphere on the outside from the internal closed space through the air outlet by the exothermic reaction can be maintained by the seal. The vacuum insulated container having a double structure with the internal closed space in the low vacuum state can be manufactured without equipment such as a vacuum pump and without time and effort. Further, since the air outlet is sealed with the seal, the vacuum insulated container can be easily manufactured without the need for sealing a vacuum hole by brazing.

(2) The exothermic reaction may be caused by contact between an alkaline earth metal oxide (for example, alkaline earth metal oxide 41 described later) and water.

With this configuration, air can be discharged from the internal closed space by water vapor generated by the exothermic reaction between the alkaline earth metal oxide and the water, and therefore, the time for manufacturing the vacuum insulated container can be shortened.

(3) The alkaline earth metal oxide may be disposed in the internal closed space, and the water may be injected into the internal closed space through the air outlet.

With this configuration, the exothermic reaction can be caused in the alkaline earth metal oxide disposed in the internal closed space only by injecting the water through the air outlet, and a process of performing the vacuum evacuation can be further simplified.

(4) The alkaline earth metal oxide may include at least one of a calcium oxide or a magnesium oxide.

With this configuration, the vacuum insulated container capable of maintaining the state of the internal closed space vacuum-pumped by the exothermic reaction using a calcium oxide or a magnesium oxide can be easily manufactured.

(5) The amount of water and the amount of alkaline earth metal oxide are set such that unreacted alkaline earth metal oxide remains in the internal closed space after the exothermic reaction.

With this configuration, the alkaline earth metal oxide remaining in the internal closed space after the exothermic reaction functions as an oxidant that adsorbs water and carbon dioxide. Moreover, by the adsorption of water and carbon dioxide, the degree of vacuum of the internal closed space can be enhanced even after the vacuum pumping.

(6) The alkaline earth metal oxide is disposed without being fixed in the internal closed space.

Since the alkaline earth metal oxide is not fixed, such an oxide moves downward in the direction of the force of gravity. Water injected into the internal closed space in this state also moves downward due to the force of gravity, and therefore, a configuration capable of reliably bringing the alkaline earth metal oxide and the water into contact with each other can be achieved with a simple structure.

(7) The seal may be configured such that water is insertable into the internal closed space after sealing of the air outlet.

With this configuration, even in a case where the degree of vacuum decreases after manufacturing of the vacuum insulated container, the degree of vacuum can be increased by the reaction caused between the untreated alkaline earth metal oxide and water injected into the internal closed space.

(8) The seal may be a check valve.

Since the seal is the check valve to be automatically sealed by a negative pressure, manufacturability is improved without the need for welding, brazing, or the like of the air outlet after the vacuum pumping. Moreover, since the seal is the check valve, the alkaline earth metal oxide or water can be injected into the internal closed space through a gap between the air outlet and a valve body of the check valve by moving the valve body to an open position at which the air outlet is opened even when the seal is attached first to the air outlet.

(9) One aspect of the present invention is a vacuum insulated container (for example, vacuum insulated container 1, la described later) including an inner container (for example, inner container 10, 10a described later) and an outer container (for example, outer container 20, 20a described later) forming an internal closed space (for example, internal closed space 40) with the inner container, which further includes an air outlet (for example, air outlet 21, 21a described later) connected to the internal closed space, a vacuum-promoting material (for example, alkaline earth metal oxide 41 described later) disposed in the internal closed space, and a seal (for example, seal 30 described later) that seals the air outlet after vacuum evacuation of gas from the internal closed space through the air outlet by the vacuum-promoting material.

With this configuration, the state of the internal closed space brought into a low vacuum by pushing out air from the internal closed space through the air outlet by the vacuum-promoting material can be maintained by the seal. The vacuum insulated container having a double structure with the internal closed space in the low vacuum state can be manufactured without equipment such as a vacuum pump and without time and effort. Further, since the air outlet is sealed with the seal, the vacuum insulated container can be easily manufactured without the need for sealing a vacuum hole by brazing.

(10) One aspect of the present invention is a vacuum insulated container (for example, vacuum insulated container 1, la described later) including an inner container (for example, inner container 10, 10a described later) and an outer container (for example, outer container 20, 20a described later) forming an internal closed space (for example, internal closed space 40) with the inner container, which further includes an air outlet (for example, air outlet 21, 21a described later) connected to the internal closed space, a seal (for example, seal 30 described later) that seals the air outlet, and an alkaline earth metal hydroxide (for example, alkaline earth metal hydroxide 42 described later) present in the internal closed space, and the internal closed space is in a low vacuum state.

With this configuration, the state of the internal closed space brought into a low vacuum by pushing out air from the internal closed space through the air outlet by an exothermic reaction between the alkaline earth metal oxide and water can be maintained by the seal. The vacuum insulated container having a double structure with the internal closed space in the low vacuum state can be manufactured without equipment such as a vacuum pump and without time and effort. Further, since the air outlet is sealed with the seal, the vacuum insulated container can be easily manufactured without the need for sealing a vacuum hole by brazing.

According to the present invention, the highly-manufacturable vacuum insulated container capable of easily bringing the internal closed space into the vacuum state can be provided.

### BRIEF DESCRIPTION OF THE DRAWINGS

FIG. 1 is a view schematically showing a vacuum insulated container according to one embodiment of the present invention;

FIG. 2 is a view schematically showing an open state of a sealing valve of the present embodiment;

FIG. 3 is a view schematically showing a closed state of the sealing valve of the present embodiment;

FIG. 4A is a schematic view showing a state when water is added to an alkaline earth metal oxide in an internal closed space of the vacuum insulated container of the present embodiment;

FIG. 4B is a schematic view showing the state of vacuum evacuation accompanied by an exothermic reaction between the alkaline earth metal oxide and the water in the internal closed space of the vacuum insulated container of the present embodiment;

FIG. 4C is a schematic view showing the state of the alkaline earth metal oxide remaining in the internal closed space of the vacuum insulated container of the present embodiment; and

FIG. 5 is a view schematically showing a vacuum insulated container of a modification.

### DETAILED DESCRIPTION OF THE INVENTION

Hereinafter, an embodiment of the present invention will be described in detail with reference to the drawings.

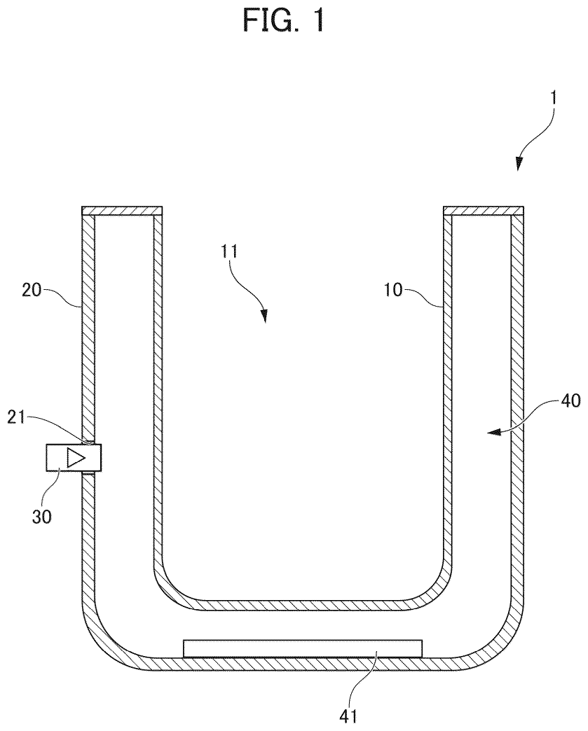

FIG. 1 is a view schematically showing a vacuum insulated container 1 according to the embodiment of the present invention. The vacuum insulated container 1 of the present embodiment has a double structure including an inner container 10 and an outer container 20.

The inner container 10 has a housing space 11 in which a housing target (not shown) such as a solid, liquid, gas, or a device is housed in the vacuum insulated container 1, and forms an inner wall portion of the vacuum insulated container 1. The inner container 10 is made of metal, for example.

The outer container 20 is capable of housing the inner container 10 therein, and forms an outer wall portion of the vacuum insulated container 1. The outer container 20 is made of metal, for example.

In the present embodiment, the inner container 10 and the outer container 20 are joined to each other such that an internal closed space 40 is formed between the outer surface of the inner container 10 and the inner surface of the outer container 20. The inner container 10 and the outer container 20 are joined to each other under an atmospheric pressure.

A method for joining the inner container 10 and the outer container 20 is not particularly limited. For example, the inner container 10 and the outer container 20 are connected to each other by a well-known method such as fastening with a fastening member such as a screw or a bolt or disposing a sealing member therebetween. More specifically, flange portions (not shown) may be formed at the upper ends of the inner container 10 and the outer container 20 so as to overlap with each other, and the flange portion of the inner container 10 and the flange portion of the outer container 20 may be sealed and fastened with a bolt. This flange portion may be formed so as to extend outward in a circumferential direction from the upper end of the side surface of the vacuum insulated container 1, or may be formed so as to bend inward of the upper end of the side surface of the vacuum insulated container 1. The joint method may be a method in which the upper ends of the inner container 10 and the outer container 20 are bent so as to approach each other and a joint portion therebetween is sealed. Since the inner container 10 and the outer container 20 are joined by a method other than welding, it is not necessary to manufacture the vacuum double-wall container by welding under substantially vacuum environment with a reduced pressure in a case where the vacuum insulated container 1 is large, and therefore, a manufacturing cost can be reduced. Note that it is not intended to exclude the case of joining these containers by welding and the inner container 10 and the outer container 20 may be joined to each other by welding in some cases.

The outer container 20 is formed with an air outlet 21 connecting the atmosphere and the internal closed space 40 to each other. In the present embodiment, the air outlet 21 is formed in a side portion of the outer container 20 at a position higher than a bottom portion of the internal closed space 40. A seal 30 is disposed in the air outlet 21, and the atmosphere and the internal closed space 40 are separated from each other.

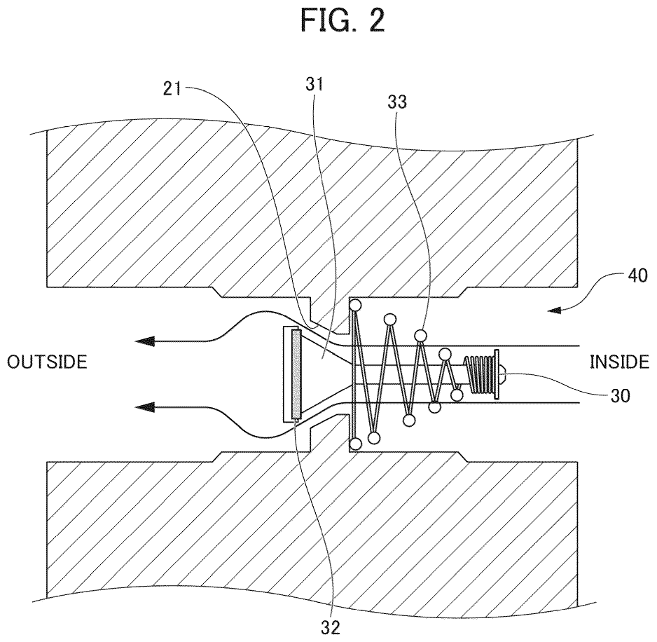

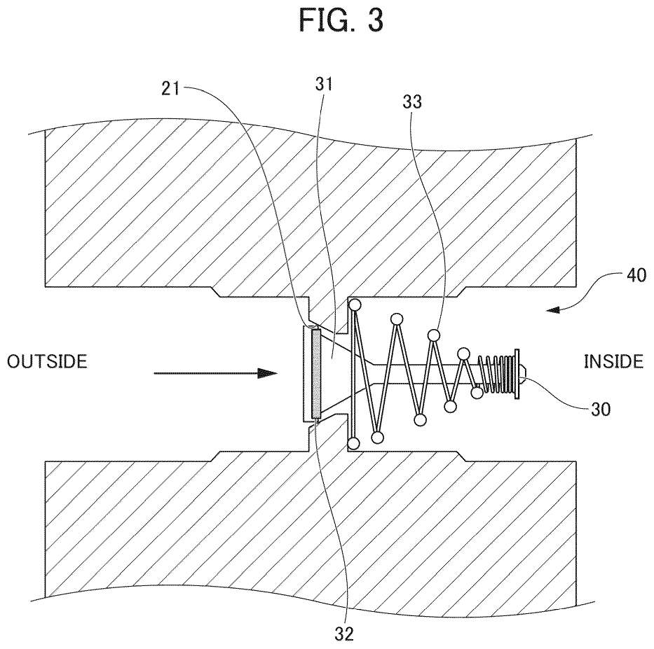

The seal 30 includes a check valve, for example. FIG. 2 is a view schematically showing an open state of the seal 30 of the present embodiment. FIG. 3 is a view schematically showing a closed state of the seal 30 of the present embodiment.

As shown in FIGS. 2 and 3, the seal 30 includes a valve body 31, a seal portion 32, and a biasing mechanism 33. The valve body 31 functions as a lid capable of closing the air outlet 21. In the present embodiment, the valve body 31 is configured such that a portion having a greater diameter than the inner diameter of the air outlet 21 is located outside the air outlet 21, and is formed in a mortar shape narrowed toward the internal closed space 40 side from the outside.

The seal portion 32 includes an O-ring and the like disposed around the valve body 31, and closes a gap formed between the valve body 31 at the closed position and the air outlet 21. The biasing mechanism 33 includes a spring and the like that applies force for biasing the valve body 31 outward from the internal closed space 40 side.

As shown in FIG. 2, when air is about to flow outward from the internal closed space 40, if force for pushing the valve body 31 outward by such a flow of air exceeds the spring force of the biasing mechanism 33, the valve body 31 of the seal 30 moves to the open position. At this open position, a space through which the air passes is formed between the air outlet 21 and each of the valve body 31 and the seal portion 32, so that the air can flow out of the internal closed space 40.

On the other hand, as shown in FIG. 3, even when air is about to flow into the internal closed space 40 from the outside, the air outlet 21 is closed and the flow of the atmospheric air into the internal closed space 40 is prevented because the valve body 31 of the seal 30 biased to the closed position by the biasing mechanism 33 has the diameter greater than the inner diameter of the air outlet 21. In the present embodiment, the air outlet 21 is formed in a mortar shape narrowed toward the internal closed space 40 side from the outside, and is in surface contact with the valve body 31 formed in the same mortar shape, and the gap between the air outlet 21 and the valve body 31 is reliably closed with the seal portion 32.

In this manner, the seal 30 is configured to allow the flow of fluid from the internal closed space 40 side to the outside while preventing the flow of fluid from the outside to the internal closed space 40 side.

The internal closed space 40 is vacuum-pumped by a chemical exothermic reaction, and is brought into a low vacuum state. The vacuum evacuation described here indicates a process of bringing a closed physical space into a negative pressure by discharging gas from such a space. The low vacuum state is, for example, a range of 105 Pa to 102 Pa. Moreover, a vacuum state in the present embodiment indicates not only an ideal vacuum state, but also a state under a more negative pressure than the atmospheric pressure, including the low vacuum state.

The vacuum evacuation of the present embodiment is performed by a chemical exothermic reaction of an alkaline earth metal oxide 41. The alkaline earth metal oxide 41 is disposed in a solid state such as a powder and granular material or a sheet in the internal closed space 40. The alkaline earth metal oxide 41 is a calcium oxide or a magnesium oxide.

The alkaline earth metal oxide 41 is a vacuum-promoting material disposed without being fixed in the internal closed space 40. A method for disposing the alkaline earth metal oxide 41 is not particularly limited. For example, the disposing method may be a method in which the alkaline earth metal oxide 41 is inserted into the internal closed space 40 through the air outlet 21 before the seal 30 is disposed in the air outlet 21 and thereafter the seal 30 is disposed in the air outlet 21. Alternatively, the disposing method may be a method in which the seal 30 is disposed in the air outlet 21 and thereafter the alkaline earth metal oxide 41 is inserted into the internal closed space 40 through the gap in a state of the valve body 31 being moved to the open state. The alkaline earth metal oxide 41 is inserted into the internal closed space 40 through the air outlet 21, and thereafter, drops onto the bottom surface due to the force of gravity and is accumulated on the bottom surface.

The alkaline earth metal oxide 41 is disposed such that unreacted alkaline earth metal oxide 41 remains after the exothermic reaction with respect to the amount of alkaline earth metal oxide 41 fully reacted in the exothermic reaction when water is added. The amount of alkaline earth metal oxide 41 may be set according to the amount of water added, or the amount of water may be set according to the amount of alkaline earth metal oxide 41.

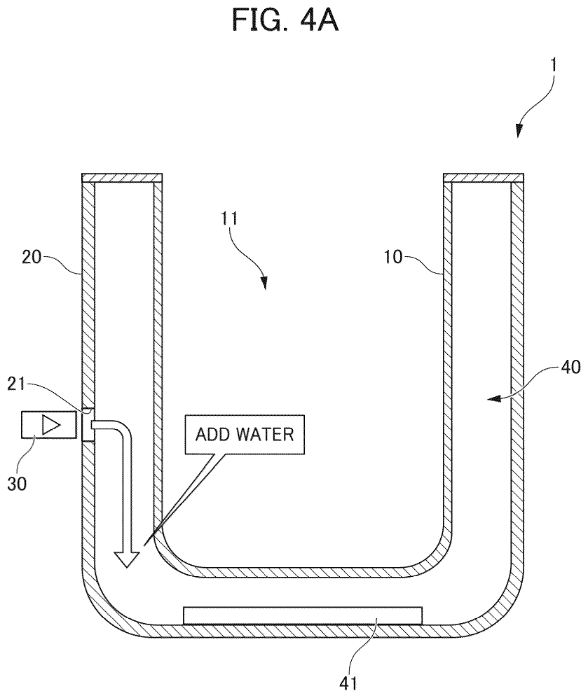

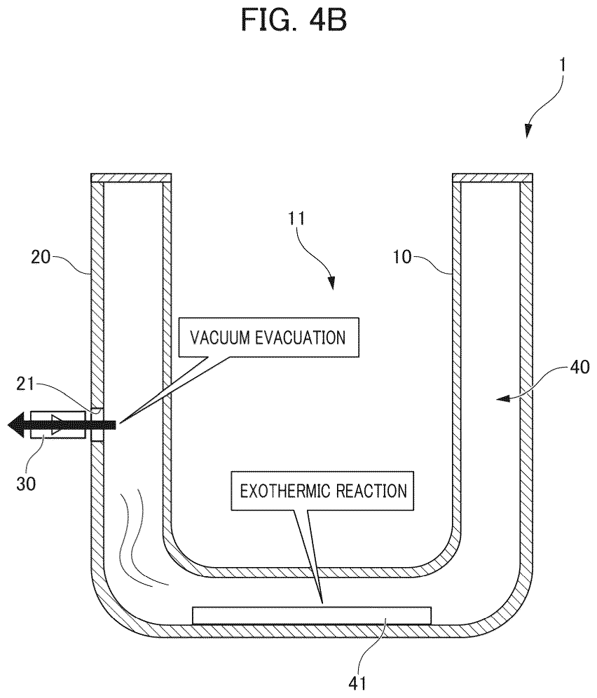

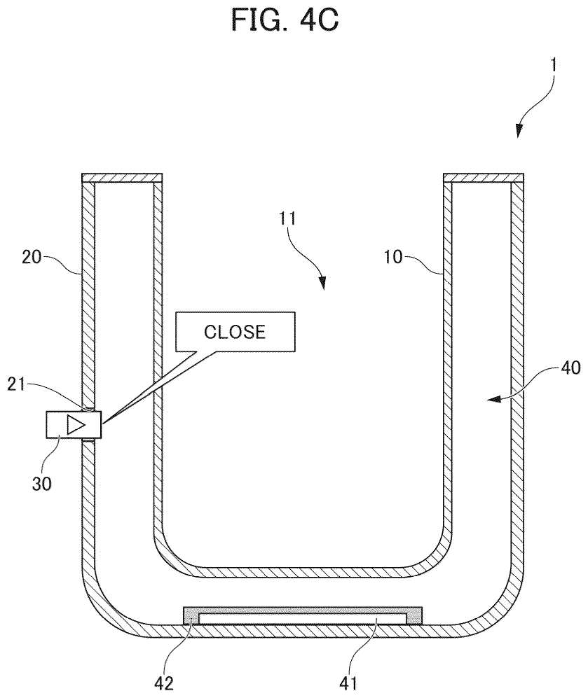

The vacuum evacuation by the exothermic reaction will be described with reference to FIGS. 4A to 4C. FIG. 4A is a schematic view showing a state when water is added to the alkaline earth metal oxide 41 in the internal closed space 40 of the vacuum insulated container 1 of the present embodiment. As shown in FIG. 4A, the water is added to the alkaline earth metal oxide 41 disposed in the internal closed space 40 in order to case the chemical reaction. For the water addition, the water is injected into the internal closed space 40 from above and the outside through the gap between the air outlet 21 and the valve body 31 in a state of the valve body 31 of the seal 30 in the air outlet 21 being moved to the open position. The water injected through the air outlet 21 drops due to the force of gravity, and contacts the alkaline earth metal oxide 41 disposed on the bottom surface.

FIG. 4B is a schematic view showing the state of the vacuum evacuation accompanied by the exothermic reaction between the alkaline earth metal oxide 41 and the water in the internal closed space 40 of the vacuum insulated container 1 of the present embodiment. As shown in FIG. 4B, the exothermic reaction is caused in the alkaline earth metal oxide 41 having contacted the water. The water injected into the internal closed space 40 changes from liquid to gas due to the exothermic reaction, and accordingly, expands about 1700 times. Water vapor is generated in the internal closed space 40, and accordingly, the flow of gas from the internal closed space 40 to the outside is generated and the vacuum evacuation of causing the gas to flow out through the air outlet 21 is performed. Note that when the water is injected into the internal closed space 40, if the seal 30 is at the closed position, the seal 30 moves from the closed position to the open position, and then, the vacuum evacuation of causing the gas to flow out through the air outlet 21 is performed.

Note that by heating or warming the inner container 10 or the outer container 20 in the exothermic reaction, the time for the vacuum evacuation can be shortened, and the injection amount of alkaline earth metal oxide 41 having exothermic and dehydration effects can be reduced.

FIG. 4C is a schematic view showing the state of the alkaline earth metal oxide 41 remaining in the internal closed space 40 of the vacuum insulated container 1 of the present embodiment. As shown in FIG. 4C, when the vacuum evacuation by the exothermic reaction ends, the gas no longer flows from the internal closed space 40 to the outside, and the valve body 31 of the seal 30 moves from the open position to the closed position to close the air outlet 21. In this manner, the outside and the internal closed space 40 are separated from each other, and even after cooling down of the inner container 10 or the outer container 20, the flow of air into the internal closed space 40 from the outside is prevented. By the vacuum evacuation by the exothermic reaction, the internal closed space 40 is brought into the low vacuum state.

In the internal closed space 40, an alkaline earth metal hydroxide 42 caused due to the reaction between the alkaline earth metal oxide 41 and the water remains. The alkaline earth metal hydroxide 42 is, for example, a calcium hydroxide in a case where the alkaline earth metal oxide 41 used for the reaction is a calcium oxide, and is a magnesium hydroxide in a case where the alkaline earth metal oxide 41 used for the reaction is a magnesium oxide.

According to the structure of the vacuum insulated container 1 of the present embodiment, even in a case where the degree of vacuum of the internal closed space 40 decreases, the valve body 31 of the seal 30 can be moved to the open position, and therefore, the alkaline earth metal oxide 41 can be added or replaced through the gap between the air outlet 21 and the valve body 31. The vacuum evacuation by the exothermic reaction can be performed by injecting water again in this state. In this manner, even after manufacturing, the degree of vacuum of the internal closed space 40 can be easily enhanced.

In the present embodiment, the amount of water and the amount of alkaline earth metal oxide 41 are set such that the unreacted alkaline earth metal oxide 41 remains in the internal closed space 40 after the exothermic reaction. That is, an excessive amount of alkaline earth metal oxide 41 is set with respect to the amount of water added. Thus, after the end of the exothermic reaction, the alkaline earth metal oxide 41 less than that initially disposed in the internal closed space 40 remains. The remaining alkaline earth metal oxide 41 can collect water and water molecules condensed due to cooling down of the water vapor after the exothermic reaction, and also collect carbon dioxide by changing into a carbonate by reaction with carbon dioxide.

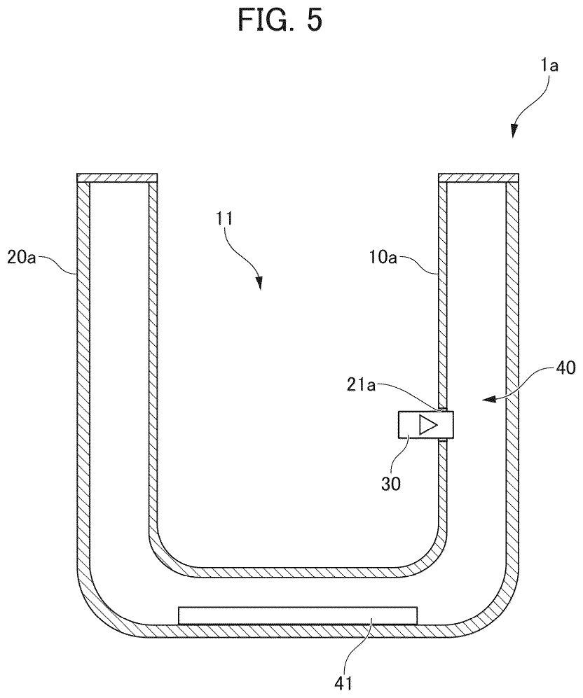

Note that in the embodiment above, the air outlet 21 in which the seal 30 is disposed is formed in the outer container 20, but the present invention is not limited to this configuration. FIG. 5 is a view schematically showing a vacuum insulated container 1a of a modification. Note that components common or similar to those described above in the embodiment are denoted by the same reference numerals and detailed description thereof will be omitted.

In the modification shown in FIG. 5, an air outlet 21a causing the internal closed space 40 and the outside to communicate with each other is formed in an inner container 10a. The seal 30 having a configuration similar to that of the embodiment above is disposed in the air outlet 21a. Note that in this modification, no air outlet 21 is formed in an outer container 20a. In this modification, effects similar to those of the embodiment above can also be obtained. The number of air outlets 21, 21a is not limited to one, and two or more air outlets 21, 21a may be formed. In this manner, the configuration of the air outlet 21, 21a, such as the number and arrangement thereof, can be changed as necessary.

The effects of the present embodiment described above will be described.

(1) The vacuum insulated container 1 (or the vacuum insulated container 1a) of the present embodiment is the vacuum insulated container 1 (or the vacuum insulated container 1a) including the inner container 10 (or the inner container 10a) and the outer container 20 (or the outer container 20a) forming the internal closed space 40 with the inner container 10, which further includes the air outlet 21 (or the air outlet 21a) connected to the internal closed space 40, and the seal 30 that seals the air outlet 21 after the vacuum evacuation by the exothermic reaction in the internal closed space 40. With this configuration, the state of the internal closed space 40 brought into the low vacuum by pushing out air into the atmosphere on the outside from the internal closed space 40 through the air outlet 21 by the exothermic reaction can be maintained by the seal 30. The vacuum insulated container 1 having the double structure with the internal closed space 40 in the low vacuum state can be manufactured without equipment such as a vacuum pump and without time and effort. Further, since the air outlet 21 is sealed with the seal 30, the vacuum insulated container 1 can be easily manufactured without the need for sealing a vacuum hole by brazing.

(2) In the present embodiment, the exothermic reaction is caused by the contact between the alkaline earth metal oxide 41 and water. With this configuration, air can be discharged from the internal closed space 40 by water vapor generated by the exothermic reaction between the alkaline earth metal oxide 41 and the water, and therefore, the time for manufacturing the vacuum insulated container 1 can be shortened.

(3) In the present embodiment, the alkaline earth metal oxide 41 is disposed in the internal closed space 40, and the water is injected into the internal closed space 40 through the air outlet 21. With this configuration, the exothermic reaction can be caused in the alkaline earth metal oxide 41 disposed in the internal closed space 40 only by injecting the water through the air outlet 21, and a process of performing the vacuum evacuation can be further simplified.

(4) In the present embodiment, the alkaline earth metal oxide 41 may include at least one of a calcium oxide or a magnesium oxide. With this configuration, the vacuum insulated container 1 capable of maintaining the state (low vacuum state) of the internal closed space 40 vacuum-pumped by the exothermic reaction using a calcium oxide or a magnesium oxide can be easily manufactured.

(5) In the present embodiment, the amount of water and the amount of alkaline earth metal oxide 41 are set such that the unreacted alkaline earth metal oxide 41 remains in the internal closed space 40 after the exothermic reaction. With this configuration, the alkaline earth metal oxide 41 remaining in the internal closed space 40 after the exothermic reaction functions as an oxidant that adsorbs water and carbon dioxide. Moreover, by the adsorption of water and carbon dioxide, the degree of vacuum of the internal closed space 40 can be enhanced even after the vacuum pumping.

(6) In the present embodiment, the alkaline earth metal oxide 41 is disposed without being fixed in the internal closed space 40. Since the alkaline earth metal oxide 41 is not fixed, such an oxide moves downward in the direction of the force of gravity. Water injected into the internal closed space 40 in this state also moves downward due to the force of gravity, and therefore, a configuration capable of reliably bringing the alkaline earth metal oxide 41 and the water into contact with each other can be achieved with a simple structure.

(7) In the present embodiment, the seal 30 may be configured such that water is insertable into the internal closed space 40 after sealing of the air outlet 21. With this configuration, even in a case where the degree of vacuum decreases after manufacturing of the vacuum insulated container 1, the degree of vacuum can be increased by the reaction caused between the untreated alkaline earth metal oxide 41 and water injected into the internal closed space 40.

(8) In the present embodiment, the seal 30 is the check valve. Since the seal 30 is the check valve to be automatically sealed by a negative pressure, the air outlet 21 is automatically sealed by the negative pressure after the vacuum pumping. A welding process, a brazing process, or the like is not necessary for the air outlet 21, and the vacuum insulated container 1 can be manufactured even without welding equipment. The vacuum insulated container 1 can be transported or the like in a state of the seal 30 being attached to the air outlet 21, and can be brought into the vacuum state at the point of use, and the manufacturability thereof can be further improved. The alkaline earth metal oxide 41 or water can be injected into the internal closed space 40 through the gap between the air outlet 21 and the valve body 31 of the check valve by moving the valve body 31 to the open position at which the air outlet 21 is opened even when the seal 30 is attached first to the air outlet 21.

(9) The vacuum insulated container 1 (or the vacuum insulated container 1a) of the present embodiment is the vacuum insulated container 1 (or the vacuum insulated container 1a) including the inner container 10 (or the inner container 10a) and the outer container 20 (or the outer container 20a) forming the internal closed space 40 with the inner container 10, which further includes the air outlet 21 connected to the internal closed space 40, the alkaline earth metal oxide 41 as the vacuum-promoting material disposed in the internal closed space 40, and the seal 30 that seals the air outlet 21 after the vacuum evacuation of gas from the internal closed space 40 through the air outlet 21 by the alkaline earth metal oxide 41. With this configuration, the state of the internal closed space 40 brought into the low vacuum by pushing out air from the internal closed space 40 through the air outlet 21 by the alkaline earth metal oxide 41 as the vacuum-promoting material can be maintained by the seal 30. The vacuum insulated container 1 having the double structure with the internal closed space 40 in the low vacuum state can be manufactured without equipment such as a vacuum pump and without time and effort. Further, since the air outlet 21 is sealed with the seal 30, the vacuum insulated container 1 can be easily manufactured without the need for sealing a vacuum hole by brazing.

(10) The vacuum insulated container 1 (or the vacuum insulated container 1a) of the present embodiment is the vacuum insulated container 1 (or the vacuum insulated container 1a) including the inner container 10 (or the inner container 10a) and the outer container 20 (or the outer container 20a) forming the internal closed space 40 with the inner container 10, which further includes the air outlet 21 (or the air outlet 21a) connected to the internal closed space 40, the seal 30 that seals the air outlet 21, and the alkaline earth metal hydroxide 42 present in the internal closed space 40, and the internal closed space 40 is in the low vacuum state.

With this configuration, the state of the internal closed space 40 brought into the low vacuum by pushing out air from the internal closed space 40 through the air outlet 21 by the exothermic reaction between the alkaline earth metal oxide 41 and water can be maintained by the seal 30. The vacuum insulated container 1 having the double structure with the internal closed space 40 in the low vacuum state can be manufactured without equipment such as a vacuum pump and without time and effort. Further, since the air outlet 21 is sealed with the seal 30, the vacuum insulated container 1 can be easily manufactured without the need for sealing a vacuum hole by brazing.

Note that the present invention is not limited to the embodiment and the modification above, and further changes, modifications, and the like within a scope in which the object of the present invention can be achieved are included in the present invention.

For example, in the embodiment above, it is configured such that water is injected through the air outlet 21, but a method for injecting water into the internal closed space 40 is not limited thereto. The vacuum insulated container 1 may be configured such that an injection port connected to the internal closed space 40 is separately formed in the inner container 10, the outer container 20, or the like and water is injected into the internal closed space 40 through the injection port.

In the embodiment above, the vacuum insulated container 1 is manufactured without using equipment such as a vacuum pump, but it is not intended to exclude use of the vacuum pump at the time of manufacturing. For example, in a state of the valve body 31 of the seal 30 configured as the check valve being moved to the open position, the vacuum evacuation can be performed also using the vacuum pump. In this manner, the degree of vacuum of the internal closed space 40 can be a higher degree of vacuum than that in the low vacuum state.

In the embodiment above, the seal 30 is configured as the one-way check valve, but the present invention is not limited to this configuration. For example, a three-way valve may be applied as the seal 30. For example, the three-way valve is capable of switching a path between an air discharge path for discharging gas from the internal closed space 40 to the outside and an injection path for injecting water and the alkaline earth metal oxide 41 from the outside into the internal closed space 40. At a stage of injecting water and the alkaline earth metal oxide 41 into the internal closed space 40, the path of the three-way valve is switched to the injection path, and at a state of performing the vacuum evacuation by the exothermic reaction, the path of the three-way valve is switched to the air discharge path. The alkaline earth metal oxide 41 may be replaced using the air discharge path. Specifically, a three-way T fitting is provided between the check valve and the container and a valve injection port is provided at the terminal thereof, so that water and the alkaline earth metal can be easily injected. In this manner, the configuration of the seal 30 can be changed as necessary.

In the embodiment above, it is configured such that the alkaline earth metal oxide 41 is disposed and thereafter water is injected in a state of the valve body 31 of the seal 30 being moved to the open position, but the present invention is not limited to this configuration. For example, the vacuum insulated container 1 may be manufactured with a configuration of disposing the alkaline earth metal oxide 41 in the internal closed space 40 and injecting water into the internal closed space 40 before the seal 30 is disposed in the air outlet 21. In this case, after the water injection, the seal 30 is disposed in the air outlet 21.

In the embodiment above, it is configured such that the alkaline earth metal oxide 41 is disposed as the vacuum-promoting material for causing the exothermic reaction in the internal closed space 40, but the present invention is not limited to the alkaline earth metal oxide 41 such as a calcium oxide or a magnesium oxide. For example, as long as the material is in the form of liquid or a solid at room temperature, expands by changing into gas by a chemical reaction, and can vacuum-pump the internal closed space 40, such a material can be disposed as the vacuum-promoting material in the internal closed space 40.

### EXPLANATION OF REFERENCE NUMERALS

1, 1a Vacuum Insulated Container
10, 10a Inner Container
20, 20a Outer Container
21, 21a Air Outlet
30 Seal
40 Internal Closed Space
41 Alkaline Earth Metal Oxide
42 Alkaline Earth Metal Hydroxide

What is claimed is:

1. A vacuum insulated container including an inner container and an outer container forming an internal closed space with the inner container, comprising:
an air outlet connected to the internal closed space; and a seal that seals the air outlet after vacuum evacuation by an exothermic reaction in the internal closed space.

2. The vacuum insulated container according to claim 1, wherein the exothermic reaction is caused by contact between an alkaline earth metal oxide and water.

3. The vacuum insulated container according to claim 2, wherein
the alkaline earth metal oxide is disposed in the internal closed space, and
the water is injected into the internal closed space through the air outlet.

4. The vacuum insulated container according to claim 2, wherein the alkaline earth metal oxide includes at least one of a calcium oxide or a magnesium oxide.

5. The vacuum insulated container according to claim 2, wherein an amount of the water and an amount of the alkaline earth metal oxide are set such that unreacted alkaline earth metal oxide remains in the internal closed space after the exothermic reaction.

6. The vacuum insulated container according to claim 2, wherein the alkaline earth metal oxide is disposed without being fixed in the internal closed space.

7. The vacuum insulated container according to claim 2, wherein the seal is configured such that water is insertable into the internal closed space after sealing of the air outlet.

8. The vacuum insulated container according to claim 1, wherein the seal is a check valve.

9. A vacuum insulated container including an inner container and an outer container forming an internal closed space with the inner container, comprising:
an air outlet connected to the internal closed space; a vacuum-promoting material disposed in the internal closed space; and
a seal that seals the air outlet after vacuum evacuation of gas from the internal closed space through the air outlet by the vacuum-promoting material.

10. A vacuum insulated container including an inner container and an outer container forming an internal closed space with the inner container, comprising:
an air outlet connected to the internal closed space; a seal that seals the air outlet; and
an alkaline earth metal hydroxide present in the internal closed space,
wherein the internal closed space is in a low vacuum state.
